(19) United States
(12) Patent Application Publication
(10) Pub. No.: US 2016/0146016 A1
(43) Pub. Date: May 26, 2016

(54) ROTOR RIM IMPINGEMENT COOLING

(71) Applicant: General Electric Company, Schenectady, NY (US)

(72) Inventors: David Richard JOHNS, Greenville, SC (US); Michael James FEDOR, Greenville, SC (US); Andrew Paul GIAMETTA, Greenville, SC (US)

(21) Appl. No.: 14/551,592

(22) Filed: Nov. 24, 2014

(51) Int. Cl. F01D 5/18; F01D 5/30

(52) U.S. Cl. CPC F01D 5/187; F01D 5/3023; F05D 2260/201

(57) ABSTRACT

A system and method of cooling a radially outer surface of a rotor wheel post of a turbine wheel and a rotor wheel space between a turbine bucket and a rotor wheel post, including a turbine bucket having at least one cooling passage that extends between an inner cooling channel of the turbine bucket and an outer surface of a shank portion of the turbine bucket that directly faces a radially upper surface of the rotor wheel post, and using the cooling passage to direct cooling flow towards the radially upper surface of the rotor wheel post.

The present invention relates to a system and method for cooling a rotor rim inside a gas turbine, and particularly relates to rotor rim cooling using cooling passages in a turbine bucket.

### BACKGROUND OF THE INVENTION

A gas turbine includes an inlet section, a compressor section, a turbine section, a combustion section, and an exhaust section. During operation, the gas turbine draws in, for example, ambient air through the inlet section, the air is compressed by the compressor section, and the air is supplied to the combustion section to generate hot exhaust gases. The hot exhaust gas is fed downstream towards the turbine section, which draws energy from the exhaust gas to drive the compressor section mechanically and produces power that can be provided as, for example, electricity.

The turbine section includes at least one rotor assembly that comprises a plurality of turbine blades circumferentially spaced and engaged in slots on a rotor wheel that are formed by a plurality of rotor wheel posts. A turbine blade has an airfoil section, a platform section, a shank section, a root section, and may also comprise a plurality of angel wings or seals that extend axially outwardly from the shank section. High temperature exhaust gas flows over the airfoil portion and the upper platform portion, and may flow into the rotor wheelspace between the turbine blades and the rotor wheel collectively and the static structures of the turbine. Hot gases flowing into the wheelspace heats the bucket shank and other nearby components of the turbine.

As exhaust gas temperature has increased in recent gas turbine designs, the wheelspace air temperature has also increased due to possible leakage of hot exhaust gas into the rotor wheelspace. Since the rotor wheel is often subject to the temperature of the air in the wheelspace, material that can be used to form the rotor wheel is dependent upon the temperature of the air in the wheelspace. Recent turbine designs have pushed against the maximum allowable temperatures of the conventionally used material to form the rotor wheel, or have used more expensive materials to accommodate the increase in rotor wheel temperature during operation due to the increase in wheelspace air temperature.

Conventionally, passive cooling schemes have been employed to cool the wheel rim, for example, by shielding the rotor wheelspace with platforms and angel wings. Another conventional scheme is purging of the wheelspace cavities and/or pressurization of the turbine blade shank cavities. However, hot exhaust air may still leak into the wheelspace, and cause the wheelspace air temperature to increase, and increase the temperature of the rotor wheel above a maximum allowable temperature of the rotor wheel material.

### BRIEF DESCRIPTION OF THE INVENTION

An active wheel rim cooling system and method has been conceived and is disclosed herein that cools the rotor rim in the rotor wheelspace. The active wheel rim cooling system and method directs cooling air from a cooling pocket and/or passage inside the turbine bucket and impinges cooling air on the dead rim portion of the rotor wheel to cool the dead rim.

A turbine bucket is disclosed herein that includes an airfoil portion, a platform portion that is radially inward of the airfoil portion, a shank portion that is radially inward of the platform portion; and a root portion that is radially inward of the shank portion. The shank portion includes at least one cooling passage extending between an inner cooling channel internal to the turbine bucket and an outer surface of the shank portion wherein the outer surface is adjacent a junction between the shank portion and the root portion.

A method is disclosed herein to cool a wheel rim gap between a turbine bucket and a rotor wheel post, including forming a plurality of cooling passages along a length of a shank portion of a turbine bucket, the cooling passages fluidly connects at least one inner cooling pocket or channel inside the turbine bucket and an outer surface of the shank portion that is in close radial proximity of the root portion of the turbine bucket; supplying a cooling gas flow to the inner cooling channel on the inside of the turbine bucket that is connected to the cooling passages; redirecting the cooling gas flow to pass through the cooling passages flow onto a radially outer surface of a rotor wheel post on a turbine wheel that is immediately abutting the cooling passages; and cooling the radially outer surface of a rotor wheel post using the cooling gas flow redirected by the cooling passages.

An turbine wheel is disclosed herein that includes a turbine wheel including a plurality of rotor wheel posts forming rotor wheel slots on a radially outer rim of the turbine wheel; turbine buckets extending radially outward from the outer rim of the turbine wheel, wherein each of the buckets includes an airfoil, a shank section and a root, wherein the root is seated in one of the rotor wheel slots; a cooling passage in the shank of each of the turbine buckets, wherein cooling passage extends between an inner cooling channel in the turbine bucket and an outer surface of the shank of the turbine bucket at a region of the shank that is abutting a radially outer surface of the rotor wheel posts; and a wheel rim gap between the turbine buckets and the rotor wheel posts. The cooling passages are adapted to direct a cooling flow from the inner cooling channel onto the radially outer surface of the rotor wheel posts and into the wheel rim gap.

### BRIEF DESCRIPTION OF THE DRAWINGS

FIG. 1 is a schematic partial cross-sectional view of a section of a turbine bucket engaged with a rotor wheel post on a rotor wheel, including a visualization of the cooling passages;

FIG. 2 is a perspective view of an embodiment turbine bucket that includes a visualization of the cooling passages;

FIG. 3 is another perspective view of an embodiment turbine bucket that includes a visualization of the cooling passages;

FIG. 4 is a front view of an embodiment turbine bucket from the side of the shank cavity that includes a visualization of the cooling passages; and

FIG. 5 is a perspective view of the outer surfaces of an embodiment turbine bucket.

### DETAILED DESCRIPTION OF THE INVENTION

As conventionally known, a turbine bucket is also called a turbine blade or a rotor blade; a rotor wheel is also called a turbine wheel; a shank portion of the turbine bucket is also called a neck portion; a root portion of the turbine bucket is also called a dovetail of the turbine bucket; and a wheel rim gap is also called a rim post gap. In the context of these descriptions, the word “about” incorporates 10% above and under the numerical value it describes.

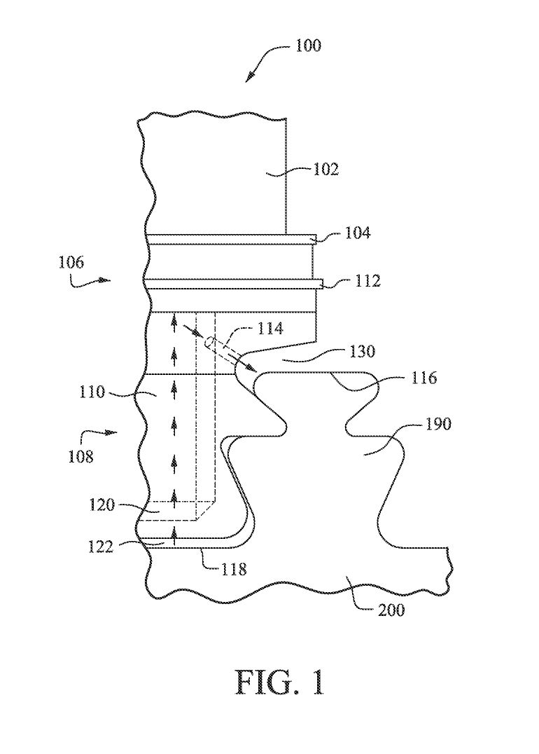

FIG. 1 shows a section of a turbine bucket 100 on a turbine wheel 200 and engaged with a rotor wheel post 190. The turbine bucket 100 has an airfoil 102, a platform 104, a shank portion 106, and a root portion 108. The shank portion 106 may include an axially extending angel wing 112 or any suitable type of seal located on the shank portion 106. The turbine bucket 100 includes at least one inner cooling channel 110 located inside the bucket 100 such that the inner cooling channel 110 supplies cooling flow 122 to the turbine bucket 100 through an opening 120 located on a radially inner part of the root portion 108. The turbine bucket 100 is engaged with a rotor wheel post 190 located on a turbine wheel 200.

As hot exhaust gas passes through the turbine buckets 100 on the turbine wheel 200, the exhaust gas may leak into the wheel rim gap 130 between the turbine bucket 100 and the rotor wheel post 190. The hot exhaust gas heats air in the wheel rim gap 130, the rotor wheel post 190 and the root portion 108 of the turbine bucket 100. The heating may cause the material temperatures in the rotor wheel post and the root portion 108 to exceed the maximum allowable temperature of conventional material used to form the rotor wheel 200 and rotor wheel posts 190.

A system and method to deliver active cooling to the wheel rim gap 130 uses at least one cooling passage 114 which extends between the inner cooling channel 110 and a surface of the shank portion 106 in the shank cavity 105 that is immediately adjacent the root portion 108 on the turbine bucket 100, and directly faces, or immediately abuts, the dead rim 116, which is a top surface of the rotor wheel post 190, or other surfaces that is adjacent to the dead rim 116. Cooling flow 122 enters the inner cooling channel 110 through an opening 120 at the radially inner part of the root portion 108, and is directed into the cooling passage 114 to provide cooling flow 122 to the wheel rim gap 130. The shank cavity 105 may be pressurized by the cooling flow 122 such that part of the cooling flow 122 is directed to flow through series of cooling passages 114.

Cooling flow 122 in the wheel rim gap 130 cools the rotor wheel post 190, including the radially outer surfaces of the rotor wheel post 190, referred to as the dead rim 116, and the radially inner surfaces of the rotor wheel post 190 that is closest to radially inner part of the root portion 108 of the turbine bucket 100. Cooling flow 122 may also be impinged upon surfaces that is on or radially inward of the dead rim 116.

The radially inner surface of the rotor wheel post 190 may be referred to as a live rim 118 of the turbine wheel 200. Cooling of the dead rim 116 also cools the live rim 118 as the cooling flow 122 travels through the wheel rim gap 130 between the root portion 108 of the turbine bucket 100 and the rotor wheel post 190.

Cooling flow 122 may be redirected to the turbine bucket 100 from a rear stage of a compressor section of the gas turbine, or be fed by an external cooling flow source. There may be at least one opening in the rotor wheel 200 that allows the cooling flow 122 to enter into the rotor wheel 200 that directs the cooling flow 122 into the opening 120 at the radially inner part of the root portion 108 of the turbine bucket 100.

The inner cooling channel 110 may have a cross-sectional shape that is rectangular, circular, triangular, oval, an irregular shape, or any combination thereof. The inner cooling channel 110 may also be straight channels or serpentine channels having substantially similar diameter throughout the entire radial length of the inner cooling channel 110, or the inner cooling channel 110 may have different diameters throughout the radial length of the inner cooling channel 110.

In another embodiment, there may be a plurality of inner cooling channel 110 inside the turbine bucket 100. In such an embodiment, each of the plurality of inner cooling channel 110 may supply cooling flow 122 to the at least one cooling passage 114, or only some of the plurality of inner cooling channel 110 may supply cooling flow 122 to the at least one cooling passage 114.

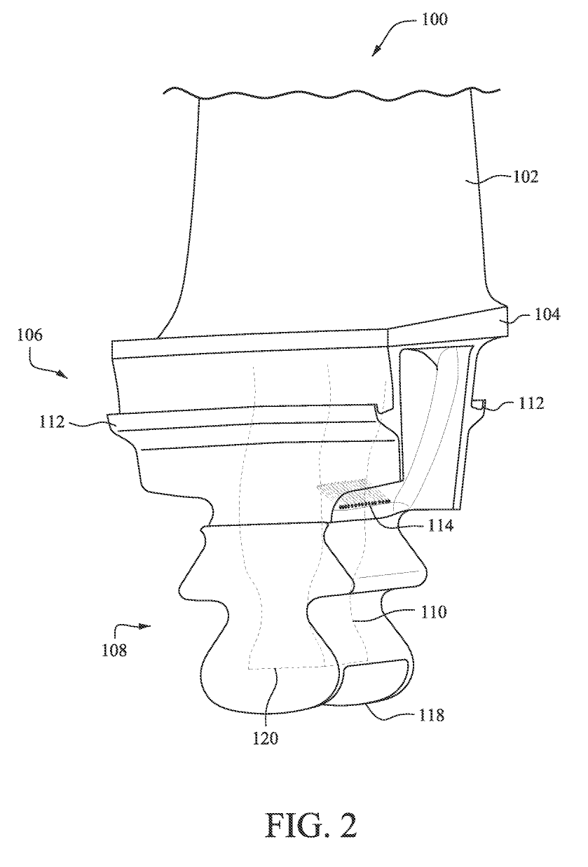

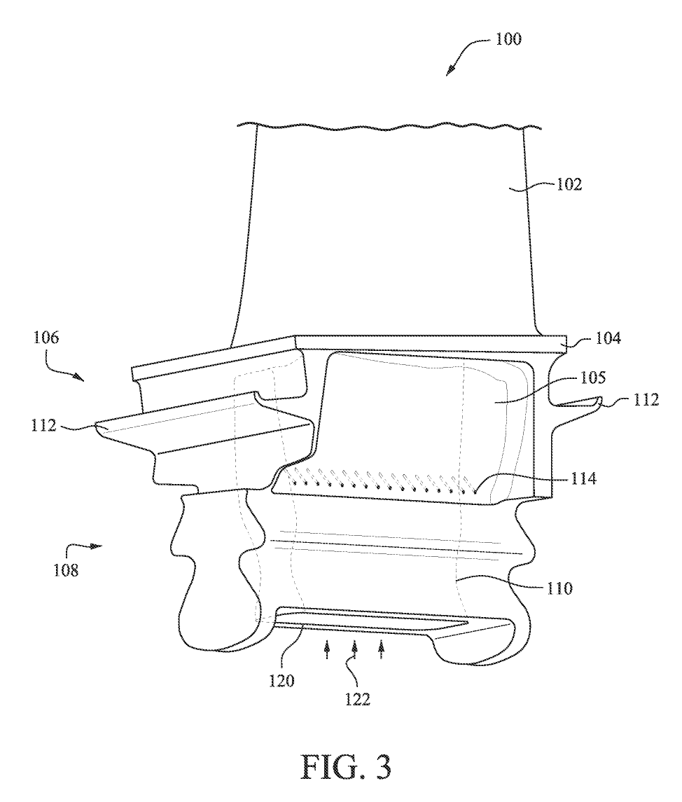

FIGS. 2 and 3 show perspective views of the turbine bucket 100 that include visualization of the inner cooling channel 110 and the cooling passages 114. The cooling passages 114 are located in an axially inner portion of the shank cavity 105 of the turbine bucket 100.

Approach angle of the cooling passages 114 is measured from an inlet of the cooling passages 114 on the inner cooling channel 110 to an outlet of the cooling passages 114 that faces the surface of the dead rim 116. The approach angle of the cooling passage 114 is preferably perpendicular to the surface of the dead rim 116. Specifically the approach angle is between about 30 degrees to about 90 degrees, preferably about 45 degrees to about 90 degrees, more preferably about 70 degrees to about 90 degrees.

For optimal heat transfer of heat away from the dead rim 116 and to shield the rotor wheel from the hot exhaust gas, the size of the cooling passage 114 can be in a ratio of “Z/D”, in which “Z” is the distance from the exit of the cooling passage 114 to the surface of the shank portion 106 that faces the dead rim 116, and “D” is the diameter of the cooling passage 114. The preferable ratio is between about 1 to about 9, more preferably between about 2 to about 8, and even more preferably between about 2 to about 6.

In an embodiment, the cooling passages 114 may be provided without slanting in any axial direction, and may be distributed uniformly along the length of the shank cavity 105. In another embodiment, the cooling passages 114 may be distributed non-uniformly along the length of the shank cavity 105.

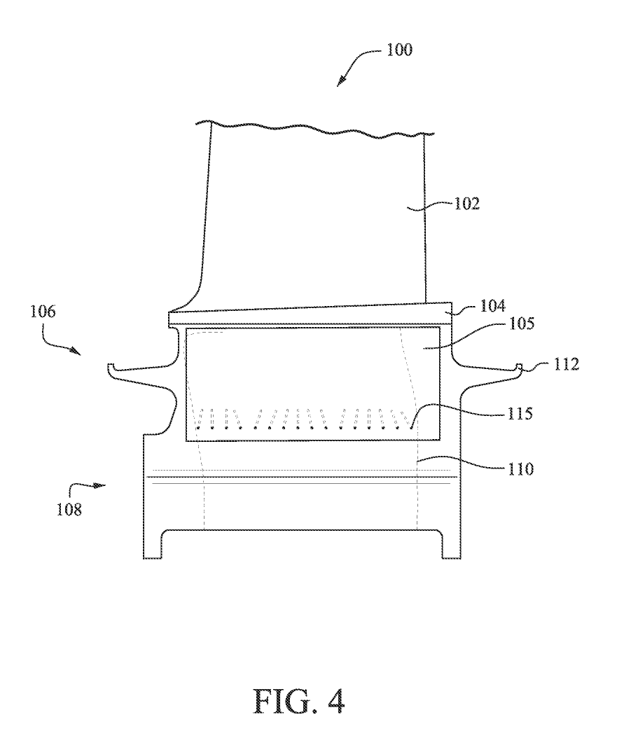

FIG. 4 shows a view of the turbine bucket 100 from the side of the shank cavity 105. The cooling passages 115 may slant in an axial direction. Slanting of the cooling passages 115 allows flexibility in accommodating different shapes of the inner cooling channel 110, and allows ability to direct cooling air towards a desired location on the dead rim 116.

In an embodiment, each of the cooling passages 115 may have different slant angles in the axial direction such that the cooling passages 115 may direct cooling flow to any desired area on the dead rim 116 of the rotor wheel post 190 as shown in FIG. 1. In another embodiment, cooling passages 115 on a single turbine bucket 100 may have different lengths and diameters, and may have different approach angles and slant angles in the axial direction.

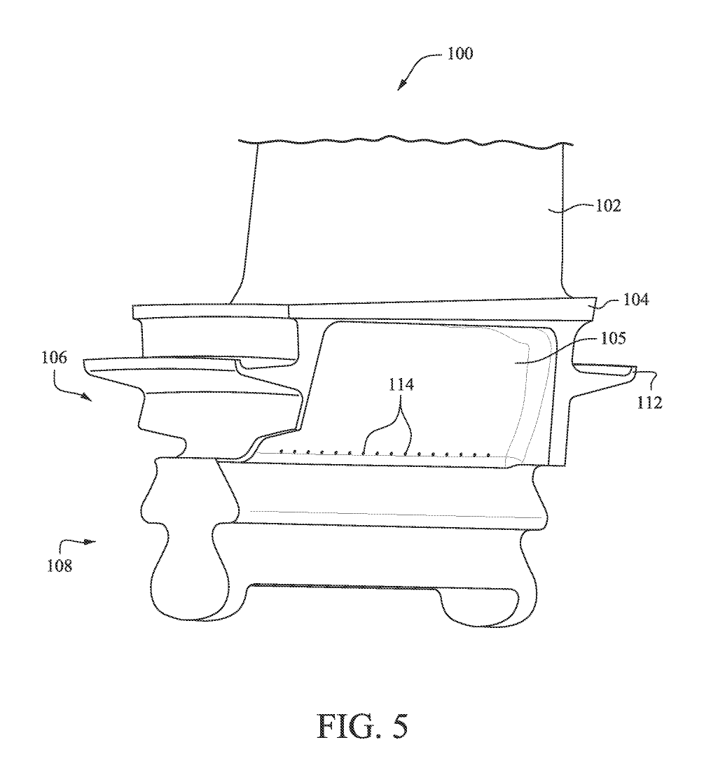

An outer body view of the turbine bucket 100 is shown in FIG. 5. The cooling passages 114 are only seen as each of the respective outlet holes that intersect the outer surface of the turbine bucket 100 in the shank cavity 105. A maximum number of cooling passages 114 that can be formed in the turbine bucket 100 is determined by the overall strength of the turbine bucket after forming the holes such that the turbine bucket retains its structural capacity. Any number of cooling passages 114 may be formed on a turbine bucket 100, up to the determined maximum number.

The present embodiments provide a system and method of providing impingement cooling of the air in the wheelspace along the dead rim between the turbine buckets of the rotor wheel posts such that the hot exhaust gas may not heat up the rotor wheel towards the maximum allowable temperature of the material.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A turbine bucket comprising:
an airfoil portion;
a platform portion that is radially inward of the airfoil portion;
a shank portion that is radially inward of the platform portion; and
a root portion that is radially inward of the shank portion;
wherein the shank portion includes at least one cooling passage extending between an inner cooling pocket or channel internal to the turbine bucket and an outer surface of the shank portion wherein the outer surface is adjacent a junction between the shank portion and the root portion.

2. The turbine bucket of claim 1, wherein the root portion of the turbine bucket is configured to engage a rotor wheel post on a turbine wheel.

3. The turbine bucket of claim 2, wherein the cooling passage is adapted to direct cooling flow towards a top surface of the rotor wheel post and/or adjacent surfaces.

4. The turbine bucket of claim 1, wherein the cooling passage has a size of a ratio of Z/D, in which Z is a distance from an exit of the cooling passage to a surface of the shank portion, and D is the diameter of the cooling passage.

5. The turbine bucket of claim 4, wherein the cooling passage has a ratio of about 1 to about 9.

6. The turbine bucket of claim 1, wherein the cooling passage has an approach angle of between about 30 degrees to about 90 degrees.

7. The turbine bucket of claim 1, wherein the cooling passage slants in an axial direction.

8. The turbine bucket of claim 1, further comprising a plurality of cooling passages, and the cooling passages are distributed uniformly or non-uniformly along a length of the shank portion.

9. The turbine bucket of claim 1, further comprising a plurality of cooling passages, and the cooling passages have non-uniform lengths and non-uniform axial slants along a length of the shank portion.

10. A method to cool a wheel rim gap between a turbine bucket and a rotor wheel post, comprising:
forming a plurality of cooling passages along a length of a shank portion of a turbine bucket, the cooling passages fluidly connects at least one inner cooling pocket or channel inside the turbine bucket and an outer surface of the shank portion that is immediately radially outward of the root portion of the turbine bucket;
supplying a cooling gas flow to the inner cooling channel on the inside of the turbine bucket that is connected to the cooling passages;
redirecting the cooling gas flow to pass through the cooling passages flow onto a radially outer surface of a rotor wheel post on a turbine wheel that is immediately abutting the cooling passages; and
cooling the radially outer surface of a rotor wheel post using the cooling gas flow redirected by the cooling passages.

11. The method of claim 10, wherein the radially outer surface of a rotor wheel post is a dead rim of the turbine wheel.

12. The method of claim 10, wherein the cooling passage has a size of a ratio of Z/D, in which Z is a distance from an exit of the cooling passage to a surface of the shank portion, and D is the diameter of the cooling passage.

13. The method of claim 10, wherein the cooling passage has a ratio of about 1 to about 9.

14. The method of claim 10, wherein the cooling passage has an approach angle of between about 30 degrees to about 90 degrees.

15. A turbine wheel and bucket assembly comprising:
a turbine wheel including a plurality of rotor wheel posts forming rotor wheel slots on a radially outer rim of the turbine wheel;
turbine buckets extending radially outward from the outer rim of the turbine wheel, wherein each of the buckets includes an airfoil, a shank section and a root, wherein the root is seated in one of the rotor wheel slots;
an cooling passage in the shank of each of the turbine buckets, wherein cooling passage extends between an inner cooling channel in the turbine bucket and an outer surface of the shank of the turbine bucket at a region of the shank that is abutting a radially outer surface of the rotor wheel posts; and
a wheel rim gap between the turbine buckets and the rotor wheel posts;
wherein the cooling passages are adapted to direct a cooling flow from the inner cooling channel onto the radially outer surface of the rotor wheel posts and into the wheel rim gap.

16. The turbine wheel and bucket assembly of claim 15, wherein the radially outer surface of a rotor wheel post is a dead rim of the turbine wheel.

17. The turbine wheel and bucket assembly of claim 15, wherein the cooling passage has a size of a ratio of Z/D, in which Z is a distance from an exit of the cooling passage to a surface of the shank portion, and D is the diameter of the cooling passage.

18. The turbine wheel and bucket assembly of claim 15, wherein the cooling passage has a ratio of about 1 to about 9.

19. The turbine wheel and bucket assembly of claim 15, wherein the cooling passage has an approach angle of between about 30 degrees to about 90 degrees.

20. The turbine wheel and bucket assembly of claim 15, further comprising a source of cooling flow drawn from an inner portion of the turbine wheel into the turbine bucket inner cooling channel.
